(19) United States
(12) Patent Application Publication
(10) Pub. No.: US 2016/0110907 A1
(43) Pub. Date: Apr. 21, 2016

(54) Animation Across Multiple Handheld Computing Devices

(71) Applicant: Danke Games Inc., Heidelberg (DE)

(72) Inventors: Dan Kelly, Baton Rouge, LA (US); Geoff Hackworth, Nottingham (GB)

(21) Appl. No.: 14/751,118

(22) Filed: Jun. 25, 2015

Related U.S. Application Data
(60) Provisional application No. 62/017,239, filed on Jun. 25, 2014.

(51) Int. Cl. G06T 13/80; G06F 3/14; G06F 3/041

(52) U.S. Cl. CPC G06T 13/80; G06F 3/041; G06F 3/1423

(57) ABSTRACT

An animation system of multiple electronic devices having displays includes that each device receives the display number for displaying an animation. Each device also receives its relative position with respect to the other devices. On each device, the user selects an animation for display and determines a start time for displaying the animation. Upon a timer of device reaching the start time, the device displays a portion of the selected animation. The displayed portion is based on the display number and the relative position of the device. The displayed portion changes while the animation moves across the devices. An advantage of the animation system includes that the devices are not required to communicate with each other while receiving the display number and relative position, while selecting the animation, while determining the start time, and while displaying portions of the animation.

### CROSS REFERENCE To RELATED APPLICATIONS

The application claims the benefit of Provisional Application No. 62/017,239, filed on Jun. 25, 2014, the content of which is incorporated herein by reference.

### FIELD OF THE DISCLOSURE

This disclosure relates to systems and methods for displaying an animation across multiple computing devices, and in particular, independent handheld computing devices that are not required to communicate with each other while displaying portions of the animation with the devices arranged in a row or grid formation.

### BACKGROUND

Displaying animations across multiple devices requires showing a sequence of images across the devices as if one large screen displays the images. For example, fans at sporting events often desire to cheer on their favorite team by displaying large animations of cheers. Instead, to cheer on the team in a manner that is visible to the team and/or television cameras filming the sports event, fans often use large signs held by several people, which consume a lot of time to make, are typically made prior to the event, and cannot be changed on the fly. Moreover, fans would likely need to produce another sign for the different events, which typically fail to include multiple messages or cheers that the fans desire to communicate during the event. Thus, animations across multiple devices are desirable, which are visibly distinguishable at a larger distance and can easily be adapted for communicating a wide variety of messages at, for example, sports events, trade shows, art galleries, and multi-display games. Oftentimes, showing animations on separate displays of multiple devices is not possible, if the devices cannot communicate with each other while the animations are being displayed.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a flowchart illustrating a method 100 for displaying an animation across a plurality of electronic devices having displays, according to some embodiments.

FIG. 2 illustrates a user interface (UI) of the animation application for receiving a display number within a setup window, according to some embodiments.

FIG. 3 illustrates an animation UI for receiving a relative position of an animation device within a setup window, according to some embodiments.

FIG. 4 illustrates an animation UI for inputting the relative positions of animation devices including a select gesture for selecting a relative position on a two-dimensional grid of displays, according to some embodiments.

FIG. 5 illustrates an animation UI for inputting the relative positions of animation devices including a select gesture for selecting a relative position on a two-dimensional grid of displays, according to some embodiments.

FIG. 6 illustrates an animation UI for selecting an animation from a set of animation packages contained in an animation library, according to some embodiments.

FIG. 7 illustrates a preview window of an animation UI that displays an animation grid for previewing an animation, according to some embodiments.

FIG. 8 illustrates an animation UI for selecting a delay time of an animation within the setup window, according to some embodiments.

FIG. 9 illustrates an animation UI displaying a visual countdown to alert the user when the animation starts, according to some embodiments.

FIG. 10 is a flowchart illustrating a method 1000 for displaying an animation across a plurality of electronic devices having displays, according to some embodiments.

FIGS. 11A-D illustrate workflow examples of applying methods 100 and 1000 through the animation UI, according to some embodiments.

FIG. 12 illustrates one embodiment of components of an example machine able to read instructions from a machine-readable medium and execute them in a processor (or controller).

The figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein. Although the figures only show one of each type of computing component or module, in practice, many types of these modules and components exist, and the various types of modules and components that are able to communicate with each other.

### Configuration Overview

An animation system, an animation application and a method for displaying an animation across a plurality of electronic devices having displays includes that each devices receives the display number of the plurality of electronic devices used for displaying the animation. The display number refers to the number of displays connected to the plurality of devices and used for displaying the animation. In addition, each device receives the relative position of the electronic device with respect to the other electronic devices of the plurality of electronic devices. On each device, the user also selects the animation for displaying across the plurality of electronic devices. The selected animation is identical for each device. Each device then determines a start time for displaying the animation.

In some embodiments, determining the start times includes synchronizing the timers of each device. In some embodiments, the synchronizing the timers includes each device detecting an orientation change condition of the device, detecting contacts with the touch sensitive surface of each device, or detecting an audio signal by each device. In some embodiments, the detections occur at the same time to synchronize the timers of each device. In some embodiments, the orientation change condition is triggered by rotating each device.

In response to the timer reaching the start time, each device displays a portion of the selected animation. The displayed portion of each device is based on the display number and on the relative position of the electronic device. While the animation moves across the plurality of electronic devices the displayed portion on each device changes.

Advantages of the animation system and method include that devices can display animations that are not connected. The animation system can be used for example in a sports stadium with a group of fans in the outdoor setting, running a cheer animation across multiple portable display devices, e.g. tablet computers, which are not connected via Wi-Fi or a cellular connection. The animation system allows a group of users to set up and start an animation within a short time period, e.g., within 10 seconds, by entering the number of displays, defining the relative position of each device, selecting an animation, and flipping each device over to start the synchronized animation.

Further advantages include that the animation application is very efficient and lightweight having an intuitive animation user interface (UI) without multiple selection screens and/or obtrusive elements. In some embodiments, setting up and starting the animation requires no more than two or three or four clicks or user interactions with the animation application. The UI of animation application includes a streamlined workflow from opening the application, to entering the display number, followed by selecting the relative position and animation, and finally starting the animation. Thus, displaying an animation across multiple unconnected devices requires few user inputs (at most four) and allows the user to focus on, for example, the sports event.

### Animation System of Multiple Independent Devices

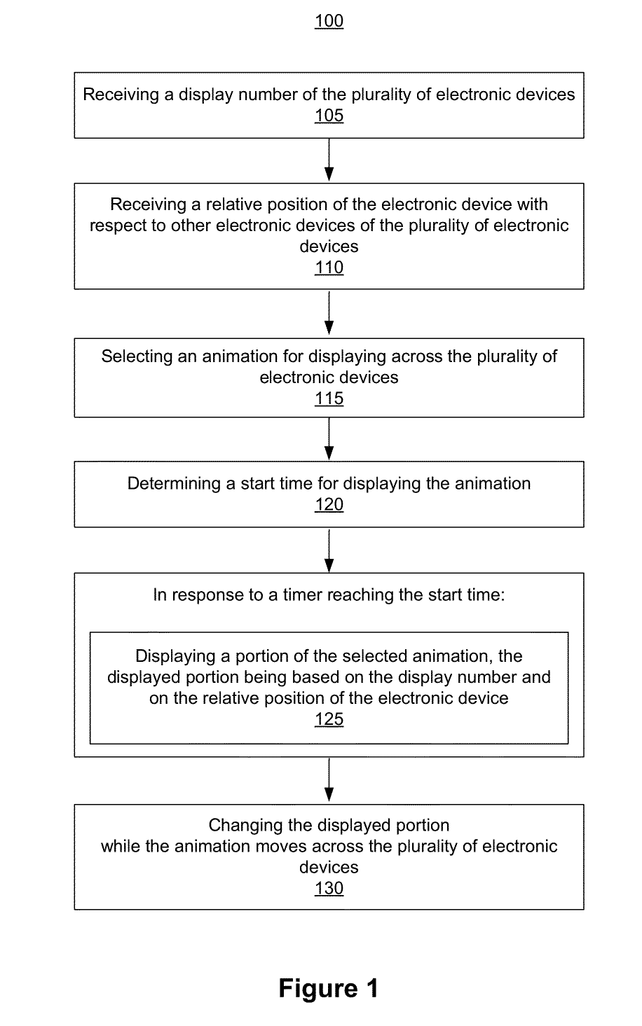

FIG. 1 is a flowchart illustrating a method 100 for displaying an animation across a plurality of electronic devices having displays, according to some embodiments. The method allows the user to display the animations across multiple displays without requiring that the electronic devices of the displays are able to communicate while the animation is being displayed.

An animation includes, for example, the process of rapidly displaying a sequence of images (frames) to create an optical illusion of perceiving continuous and realistic motion of the displayed characters and/or shapes. In some embodiments, animations include a sound file that is played while the animation is shown. The images included in an animation can be recorded in various formats, including digital media format, e.g. animated Graphics Interchange Format images or Flash animation files in Small Web Format (SWF). During the animation, the frames are displayed in rapid order with at a rate of 24, 25, 30, or 60 frames per second.

To display an animation across multiple devices having multiple displays, the size of the animation is divided into separate portions, according to some embodiments. The combination of consecutive frames constitutes a portion of the animation that is shown on one display, while other portions of the animation are shown on the other displays at the same time. For example, at the time that the first frame of a first portion is shown on a first display, the first frame of a second portion is shown on a second display. Each device then loops through all portions of the animation while the animation moves across all devices with the order of the portions depending on the relative position of the device with respect to the other devices. To determine the number of animation portions for displaying the animation across a plurality of electronic devices, each device receives the display number of the plurality of electronic devices.

In addition to the frame rate and the duration of the animation, the display number determines the size of each animation portion, i.e. the number of consecutive frames included in the portion, and the number of portions. In some embodiments, the size of each animation portion equals the total number of frames divided by the display number. Thus, the size of an animation portion determines the time delay for a particular frame to be shown on two different displays. For neighboring displays, in some embodiments, the time delay equals the portion size divided by the frame rate. In some embodiments, the user manually inputs the display number on each device.

In alternative embodiments, to display an animation across multiple devices having multiple displays, each frame is divided into separate, non-overlapping frame regions. By dividing the animation this way, each region of a frame is shown at the same time on different displays. In this embodiment, the combination of consecutive frame regions constitutes a portion of the animation that is shown on one display, while the other portions of the animation are shown on the other displays. Each portion is only shown on one particular display. The size of each portion equals the size of the animation, and the number of portions depends on the display number. In some embodiments, the number of portions equals the display number.

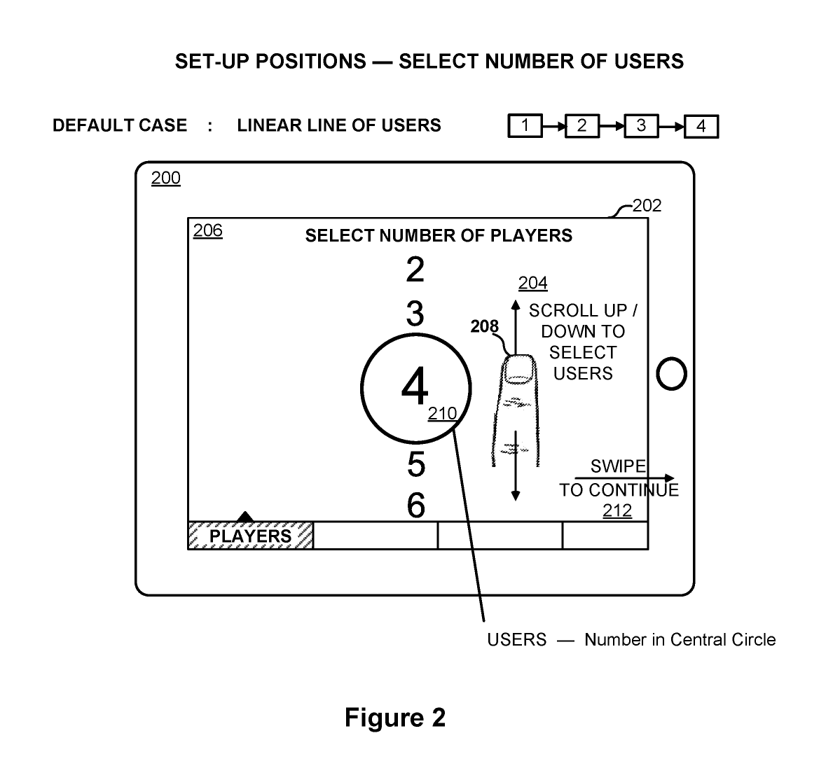

The method 100 is performed at an electronic device with a display and an input device, such as the portable multifunction device 200 with display 202 shown in FIGS. 2-9, as may be controlled by specially programmed code (computer programming instructions) contained in a graphics module, wherein such specially programmed code is not natively present in the device 200. In some embodiments, the display 202 includes a touch sensitive surface. Other embodiments of the electronic device include portable computing device, e.g., a laptop computer, a phone, or any similar computing devices. Some embodiments of the method 100 may include fewer, additional, or different steps than those shown in FIG. 1, and the steps may be performed in different orders. The steps of the method 100 are described with respect to example user interfaces illustrated in FIGS. 2-9.

Referring to FIG. 2, each electronic device receives 105 a display number of the plurality of electronic devices. In some embodiments, the user inputs on each device the number of players or users participating in displaying the animation. Each player corresponds to a separate device having a single display. In this embodiment, the number of players equals the number of devices, which equals the display number. In some embodiments, the display number depends on the number of players without being equal to the number of players. For example, one player may hold up two or more display devices in a vertical direction when participating in displaying the animation. In this example, the displays are arranged on a grid. In some embodiments, the displays are arranged in a row that forms a horizontal linear line of displays.

As illustrated in FIG. 2, in some embodiments, inputting the display number or number of players includes a scrolling gesture (or input to scroll) 204 within the setup window 206 of the animation UI. In some embodiments, a scrolling gesture 204 includes a swipe or flick in a direction substantially vertically from top to bottom or bottom to top relative to electronic device 200 through a contact 208 of the user's finger with the touch-sensitive display 202 within the user interface (UI) of the animation application. In some embodiments, the scrolling gesture is clicking and dragging a scroll element with a mouse or cursor at the location on the display corresponding to the scroll element. In some embodiments, the user adds or deletes a player to the number of players by dragging a player icon from a player icon set to a location on the display corresponding to a relative position within the grid of available positions. In some embodiments, the user creates the grid of relative positions by dragging player icons within a location of the display corresponding to region defined by the boundaries of the grid. In response to the electronic device detecting the scroll gesture, the animation UI shows and/or highlights the display number or number of players 210 on the display 202. In some embodiments, upon detecting a vertical scrolling gesture on the display 202, the electronic device receives 105 the display number 210 shown on the animation UI. Furthermore, following a horizontal scrolling gesture 212, the electronic device displays an option for the user or player to select the relative position of the user's electronic device with respect to other user's electronic devices participating in displaying the animation.

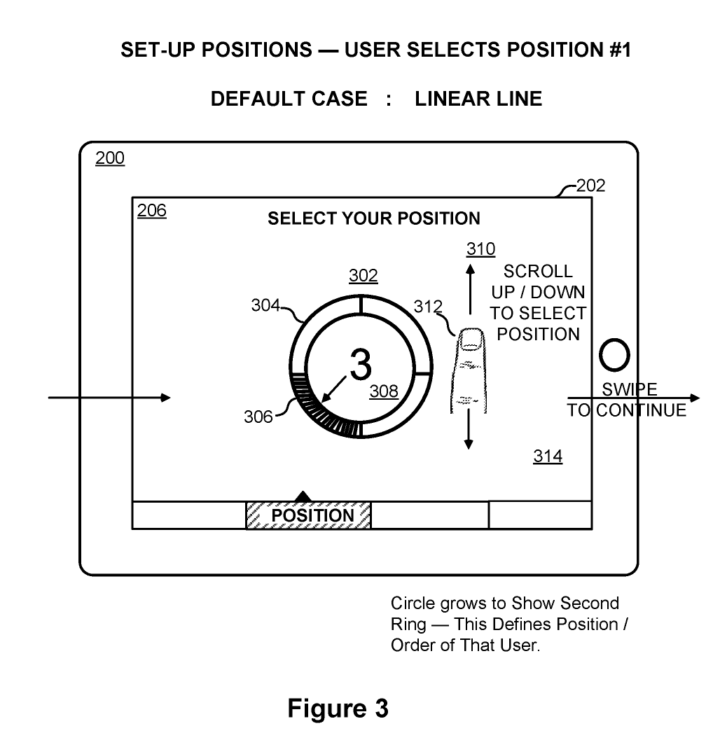

Referring to FIG. 3, each electronic device receives 110 the relative position of the electronic device with respect to other electronic devices of the plurality of electronic devices. In some embodiments, the user inputs the relative position of the user's device by selecting a position from the set of available positions. In some embodiments, the number of the available positions equals the display number 210. In some embodiments, the animation UI displays ring 302 with ring segments 304, each ring segment corresponding to a particular position or order among the available positions. In these embodiments, an inputted or selected relative position 306 is visibly distinguished from other positions, e.g., by highlighting the ring segment corresponding to the selected relative position and/or displaying a digit pointing to the highlighted ring segment as illustrated in FIG. 3. In some embodiments, the animation UI displays the relative position as number 308 that the user inputs or selects. In some embodiments, the user selects or changes a relative position through a selection gesture 310 that includes a contact 312 on the touch sensitive surface of the device display at a location of one of the available positions.

In some embodiments, the animation application automatically generates the relative positions of each device participating in displaying the animation. Through a near-network connection, e.g., a Near Field Communication (NFC) or Bluetooth connection, each device senses the presence of the other devices. Through the near-network connection, the animation application on one of the devices sends a request signal to all within range devices, which invites the other device to participate in the animation. The other devices receive the request signal through the animation application executing on these devices. Upon accepting the invitation, the animation applications on each device automatically generate the devices' relative positions through sensing the distance and direction of each device via the near-network connection.

In some embodiments, the animation application provides a default orientation of the display of each device participating in the animation. For example, the default orientation is the landscape orientation of the device with the long-axis of the device being aligned approximately horizontal with respect to the other devices. In some embodiments, the user specifies the orientation of the user device through the animation UI. If the user specifies an orientation that differs from the default orientation, all other user update the orientation for this device through the setup window, accordingly. In some embodiments, the animation UI provides a user with the option to select the device orientation from a set of predefined orientations that the animation application determines from accessible device parameters. A set of predefined orientations, for example, includes the portrait orientation and landscape orientation of the device. In some embodiments, the animation application uses information provided by an orientation sensor such as a magnetometer or an accelerometer that indicates the orientation of the device relative to a respective frame of reference such as the earth's magnetic or gravitational field to determine the current orientation of the device. The current orientation is then selected as the device orientation while the animation is being displayed.

As illustrated in FIG. 3, in some embodiments, inputting the relative position includes a scrolling gesture (or input to scroll) 310 within the setup window 206 of the animation UI. In some embodiments, a scrolling gesture includes a swipe or flick in a direction substantially vertically from top to bottom or bottom to top relative to electronic device 200 through a contact 312 of the user's finger with the touch-sensitive display 202 within the user interface of the animation application. In some embodiments, the scrolling gesture is clicking and dragging a scroll element with a mouse or cursor at the location on the display corresponding to the scroll element. In response to the electronic device detecting the scroll gesture, the animation UI displays the number 308 of the selected relative position. In some embodiments, upon detecting a horizontal scrolling gesture 314 on the display 202, the electronic device receives 110 the relative position of the electronic device. Furthermore, following a horizontal scrolling gesture 314, the electronic device displays additional options for the user or player to select for setting up the animation.

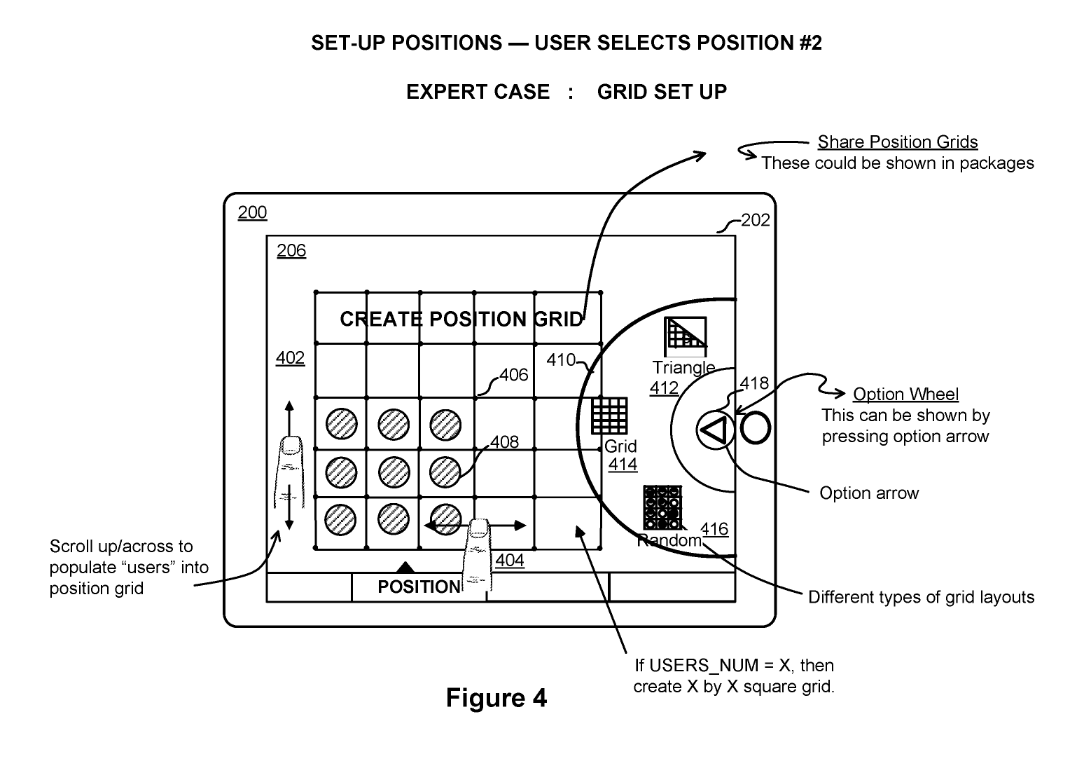

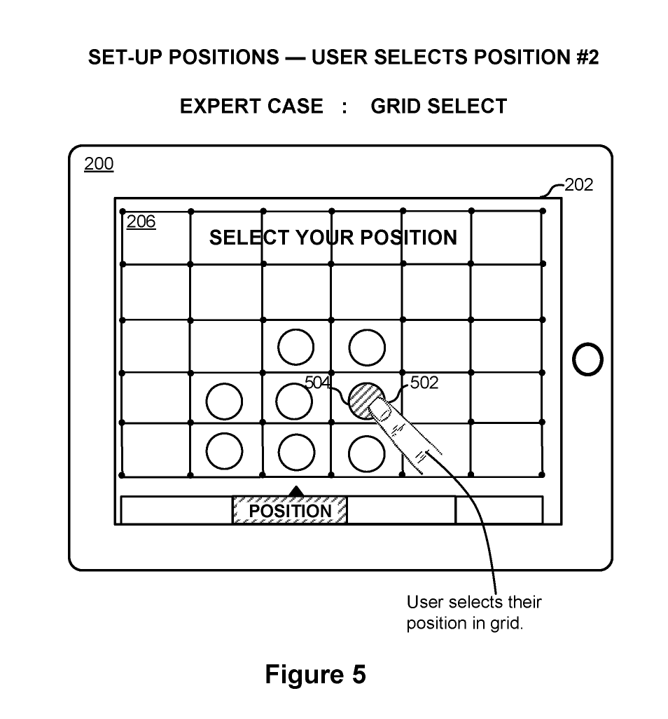

As illustrated in FIGS. 4 and 5, in some embodiments, inputting the relative positions includes a select gesture for selecting a relative position on a two-dimensional grid of displays. In some embodiments, the number of available positions on the grid equals the square of the number of users or players. A vertical scrolling gesture 402 and horizontal scrolling gesture 404, which are similar to the above scrolling gestures, allow the user to display various parts of the grid 406 within the setup window 206 of the animation UI as shown in FIG. 4. In some embodiments, each position is represented by an empty or lightly shaded circle 408 enclosed by gridlines within the setup window 206 of the animation UI. In some embodiments, the animation UI displays an option wheel 410 for selecting different types of grid layouts, e.g., triangular grid 412, rectangular grid, square grid 414, hexagonal grid 416, oblique grid or the like, through a selection gesture. In some embodiments, this selection gesture includes a contact on the display surface that moves in a circular movement along the surface at the location of the option wheel.

In response to selecting a particular grid type, the grid type displayed on the setup view of the animation UI is changed to the selected grid type. In some embodiments, an option arrow 418 visibly distinguishes the selected grid type from the unselected grid type of the option wheel. As illustrated in FIG. 5, in some embodiments, inputting the relative position includes a select gesture within the setup window 206 of the animation UI. In some embodiments, the selection gesture includes a contact 502 on a touch-sensitive surface at a location corresponding to a selectable relative position in the grid. In some embodiments, the selection gesture is clicking with a mouse or cursor at the location on the display corresponding to the selectable relative position. In some embodiments, upon selecting a relative position, the circle 504 corresponding to the selected relative position is displayed visibly distinguished from the other unselected positions by, e.g., highlighting or shading in a darker color of the circle corresponding to the selected relative position.

In addition to the display number and relative position, each electronic device selects 115 an animation for displaying across the plurality of electronic devices. The selected animation application executes on multiple user devices (e.g., tablet computer) and displays its animation moving across the devices that act as a multi-screen display. In some embodiments, a first user interacts with the animation application that executes on one of the devices to set up the animation. In some embodiments, the user designs the animation by entering a text in form of a character string that is displayed as part of the animation. In some embodiments, the user selects objects from a list displayed in the animation UI that are displayed as part of the animation. In these embodiments, the user defines an arrangement of the entered text and the selected objects during the animation. The user-defined the arrangement includes, for example, a rate and a direction of movement of the text and the objects, which determines how the text and/or objects are animated. In some embodiments, the user selects a predefined animation stored in an animation database on the user's electronic device. In some embodiments, the user further interacts with the animation application to define particular properties of the designed or predefined animation, such as sizes and colors of text and objects.

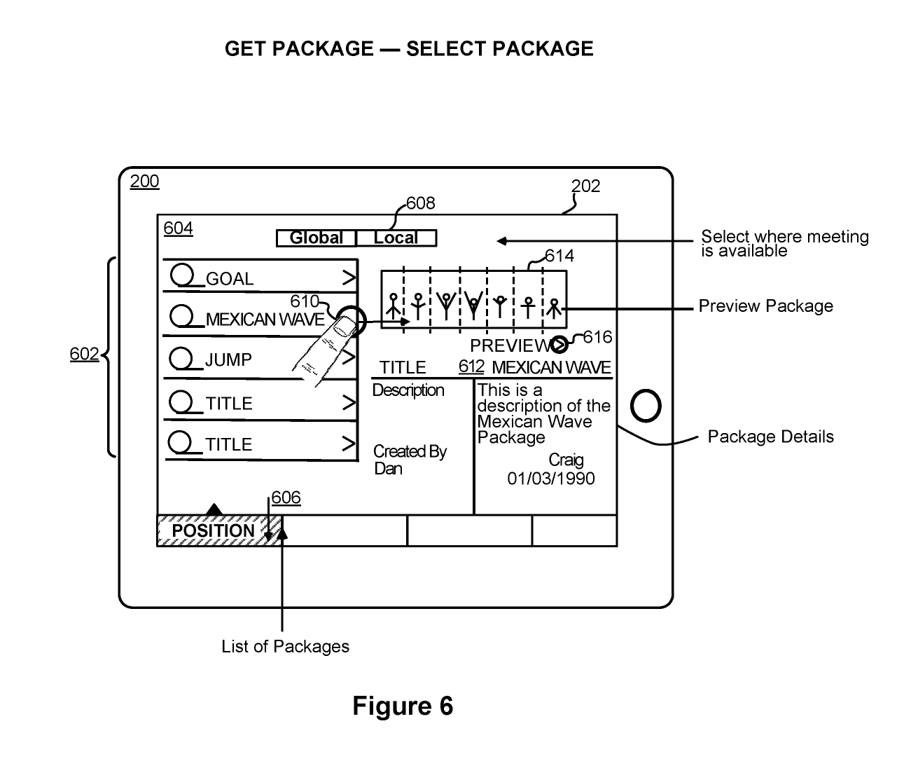

As illustrated in FIG. 6, in some embodiments, the user selects 115 an animation from a set of animation packages contained in an animation library. The animation library includes predefined animations provided by the animation application, user-created animations, or animations obtained from a marketplace of animations that allows downloading additional animation packages. In some embodiments, the animation applications provide the user to download animation packages that directed to sports team themed or related animations. These themed animations include, for example, team-based colors, team-specific chants, team logo, and the like. In addition, a user is able to download animations for multiple teams, while having the option to be notified and obtain updates to these animations, e.g., when the team logo changes. Downloading animation packages to be included in the animation library allows using the animation when a device is offline, i.e. not connected through a network to servers providing these animation packages. In some embodiments, a particular animation package is selected as active so that the corresponding animation is preselected with default parameters and ready for displaying upon opening the animation application on a device.

The animation UI displays the available animation package as a list of packages 602 within a selection window 604. A vertical scrolling gesture 606 allows the user to scroll upwards and downwards among the available animation packages if the list 602 extends past the displayed selection window 604. In some embodiments, the selection window includes a selection option 608 that allows the user to select where the package is available, e.g., the package has “Global” or “Local” availability. Global availability refers to the animations that can be downloaded from external sources, e.g., a network marketplace. Local availability refers to animations that the user created locally on the device and require sharing from the device with any other devices participating in displaying this animation.

In some embodiments, selecting 115 an animation from the displayed list includes a selection gesture within the selection window of the animation UI. In some embodiments, the selection gesture includes a contact 610 on a touch-sensitive surface at a location corresponding to a selectable animation. In some embodiments, the selection gesture is clicking with a mouse or cursor at the location on the display corresponding to the selectable animation. Upon detecting the selection gesture, additional information 612 about the selected animation are displayed within the selection window, which includes a preview window 614 that allows previewing the animation. In some embodiments, a vertical scrolling gesture allows for scrolling (stepping through) through the preview of the animation. In some embodiments, the preview window includes “play” button 616, a “rewind” button, a “forward” button, a “stop” button, a “repeat” button, a “pause” button or any combination thereof, which allow playing a preview of the animation. Additional information about an animation includes the animation title, a description of the animation, the animation's date of creation, the author of the animation, and the like.

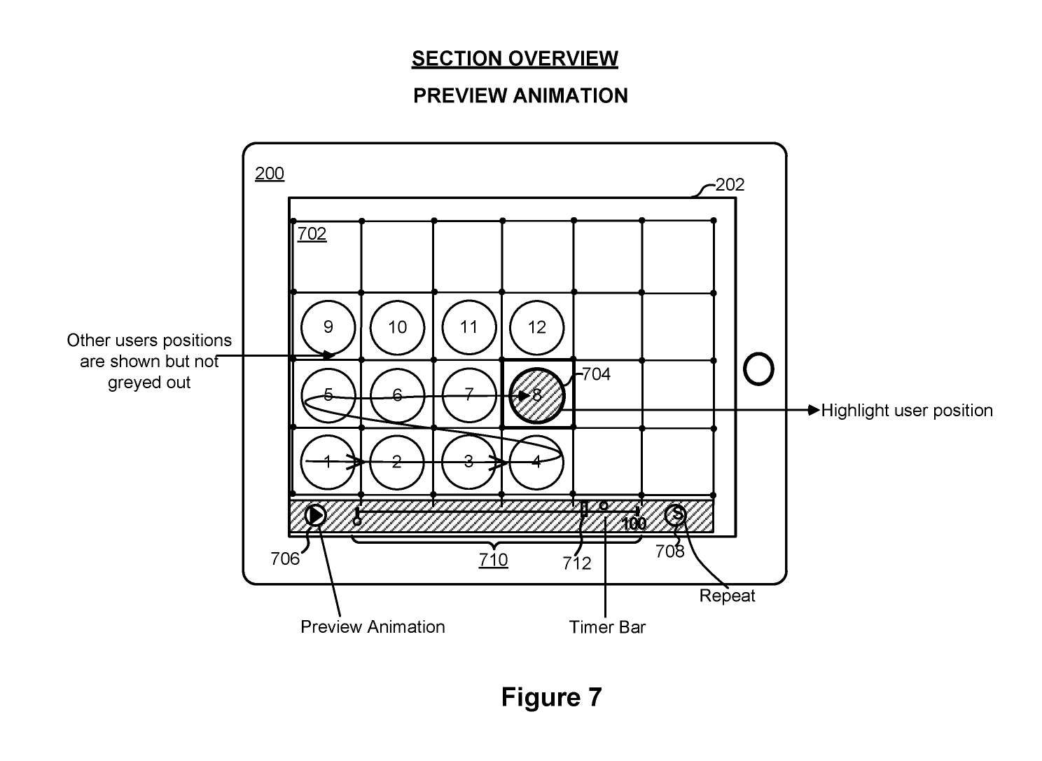

In some embodiments, as illustrated in FIG. 7, the preview window 702 displays the animation grid for previewing the animation. In the displayed grid, the relative position 704 of the current device is visibly distinguished from the other devices by, e.g., highlighting the particular relative position and greying out the other positions. The embodiment of FIG. 7 also includes a “play” button 706 and a “repeat” button 708 in addition to a timer bar 710 that indicates the total time of the previewed animation. While previewing the animation a time indicator 712 is displayed moving along the time bar to indicate the animation time. In some embodiments, a scrolling gesture including a contact at the location of the time indicator and moving the contact in a substantially horizontal direction along the surface of the display allows fast forwarding or rewinding the preview of the animation.

In some embodiments, the first user associates the animation with a particular location, such as a section number, row number, and seat number in a stadium. After an animation has been set up, the animation application generates a machine-readable code, e.g., a QR code, a barcode, or a numeric code, that contains information about the animation. To join the animation configured and/or designed by the first user, other users enter or scan the machine-readable code generated by the animation application that executes on the first user's device using the animation applications executing on the other users' devices. In some embodiments, the user of each device also enters display number and the relative position (location) of the device relative to the first device as described in detail above. In some embodiments, after designing or selecting animation the animation application is configured to display the machine-readable code containing information of the designed or selected animation to enable other devices to join the animation. A user is able to switch between setup windows of the animation UD to a setup window that displays information for other user to join in displaying the animation. The displayed information includes, for example, the QR code and other information about the text and objects of the animation.

Furthermore, each electronic device determines 120 a start time for displaying the animation. In some embodiment, a trigger event at each of the devices determines a start time. In some embodiments, the trigger event further starts the animation and the timer on each device. In some embodiments, determining the start time includes synchronizing the timer of each device. By synchronizing the timer, each device starts animation at the same time, which results in the portions of the animation displayed on each device being synchronized. In some embodiments of synchronizing the timers, each device detects an orientation change condition. In some embodiments, the trigger event for synchronizing the timers includes a contact with the touch sensitive surface of the device display. In some embodiments, the trigger event includes pressing or pushing a physical button or switch on the device. In some embodiments, the trigger event and the orientation change condition are identical. Since the orientation change condition on each device are synchronized, the start times of the portion of animation on the separate devices is approximately identical. For example, the start times differ only by a few milliseconds, which does not affect how an observer perceives the synchronization of the animation across all devices. Upon detecting the orientation change condition, each device starts the device's timer. In some embodiments, the orientation change condition is triggered by rotating the electronic device. An example trigger event starting the animation and timers is a synchronized rotation of the devices. For example, the users flip the devices over in synchrony, triggering the start of the animation. In some embodiments, the orientation change condition is triggered by changing the display of the electronic device from facing forward to facing backward to back to facing forward.

Additional trigger events for synchronizing the device timers include each device detecting an identical audio signal. In some embodiments, the users receive an audio cue from one of the device to time when to issue the trigger event. Audio cues allow the user to connect to the animation, since users likely hold up the device with the display facing away from them. The audio cues inform the user when to start the animation, when each display is active, or when the animation has completed after a final audio cue. In some embodiments, the animation application automatically starts upon detecting or receiving a predefined audio cue from one of the device or an separate external device, e.g., a stadium speaker. An example of an audio cue for starting an animation includes a commentator announcing that a team has scored over the stadium speakers by shouting “goal.” Another example of an audio cue includes three consecutive beep sounds followed by a whistle sound, which results in the animation application starting a “crowd cheering” animation to move across the device displays. In some embodiments, the pitch of the beeps relate to the relative position of the device with respect to the other devices.

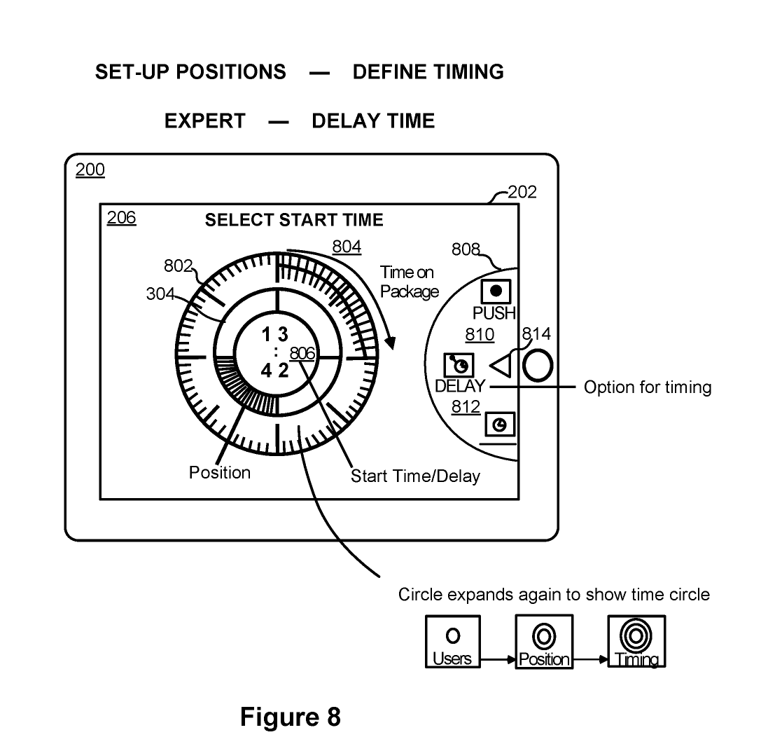

In some embodiments, the time of synchronizing the timers and the start time differs by a specified time threshold, resulting in a delay between when the devices are synchronized and when the animation starts. As illustrated in FIG. 8, a user is able to select a delay time within the setup window 206 of the animation UI. In some embodiments, the delay time is selected by clockwise turning a radial dial 802 displayed in the setup window 206. Upon turning the radial dial clockwise, the delay time increases from zero to the time indicated on the dial at the top point. A dial gesture for turning the displayed radial within the setup window includes a contact 804 on the display surface that moves in a circular movement along the surface at the location of the radial dial 802. In some embodiments, the start time or delay 806 is displayed in the center of the radial dial 802. In some embodiments, the ring 304 with ring segments is displayed within the setup window 206 with the ring being encompassed by the radial dial 802, as illustrated in FIG. 8. In some embodiments, the animation UI displays an option wheel 808 for selecting the timing of the animation, e.g., push 810, delay 812, countdown and the like, through a selection gesture. In some embodiments, this selection gesture includes a contact on the display surface that moves in a circular movement along the surface at the location of the option wheel for timing selection. In some embodiments, an option arrow 814 visibly distinguishes the selected animation timing from the unselected timings of the option wheel.

In response to the timer reaching the start time, the electronic device displays 125 a portion of the selected animation, which is based on display number and the relative position of the electronic device. The animation application on each device displays the animation across the set of user devices that joined the animation. If the devices are arranged in a row, a device at one end of the row starts the animation and the animation applications executing on each of the other devices display the animation in sequence. Thus, if the devices are held in a row adjacent to one another, the animation moves across the row of devices.

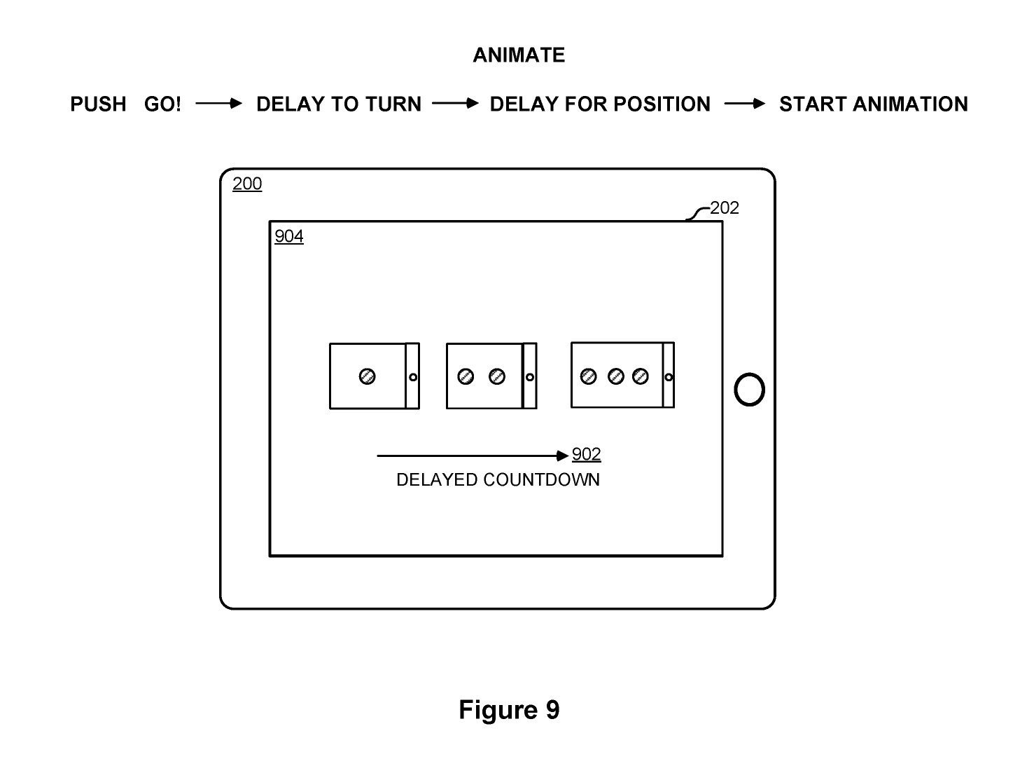

The animation application executing on each device independently displays portions of the animations on its device. In some embodiments, as illustrated in FIG. 9, prior to displaying portions of the animation, a visual countdown 902 is displayed within a countdown window 904 of the animation UI on the device to alert the user when the animation starts. Showing a visual countdown 902 indicates to the user when to place the device at the correct physical location with respect to the other device facing the same direction to form a multi-device display. In some embodiments, the countdown 902 accounts for the delay caused by the user turning the device and the delay for positing the device with respect to the other device. As described with respect to FIG. 8, the user can specify a total delay time that includes the delay to turn and the delay to position the device. In some embodiments, the user separately specifies both delay times.

Each animation application determines its relative distance from the device at the end of the row based on its relative position among the devices and the display number. In some embodiments, the relative distance also accounts for the size of each display, which the users input on each device for each display in addition to the display number. Based on the rate of movement of the animation and the distance of the device from the end device, the animation application executing on each device determines a time to display the animation, which includes the amount of time needed for the animation to move across the devices from the device executing the animation application to the end device. This allows each animation application to display animations across multiple devices without the devices communicating with each other, e.g., via a network.

The device through the animation application changes 130 the displayed portion while the animation moves across the plurality of electronic devices. While moving the animation across the displays of devices that have joined a group, the animation application displays the animation, which includes, for example, animation text and/or objects. Users of multiple devices interact with the animation application to join a group of devices.

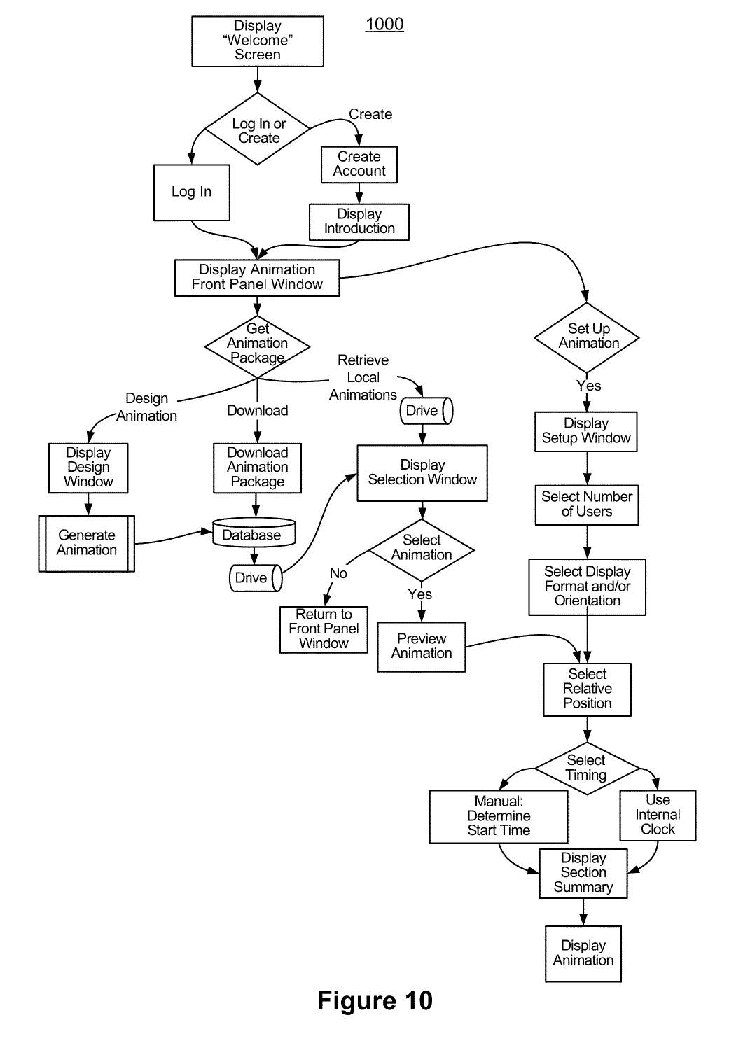

FIG. 10 is a flowchart illustrating a method 1000 for displaying an animation across a plurality of electronic devices having displays, according to some embodiments. The method allows the user to display the animations across multiple displays without requiring that the electronic devices of the displays are able to communicate while the animation is being displayed. The method 1000 is performed at an electronic device with a display and an input device, such as the portable multifunction device 200 with display 202 shown in FIGS. 2-9, as may be controlled by specially programmed code (computer programming instructions) contained in a graphics module, wherein such specially programmed code is not natively present in the device 200. In some embodiments, the display 202 includes a touch sensitive surface. Other embodiments of the electronic device include portable computing device, e.g., a laptop computer, a phone, or any similar computing devices. Some embodiments of the method 1000 may include fewer, additional, or different steps than those shown in FIG. 10, and the steps may be performed in different orders. The steps of the method 1000 are described with respect to example user interfaces illustrated in FIGS. 2-9.

The method 1000 provides users of the animation application the option to create an animation account. In some embodiments, the user optionally logs into the account before starting an animation. The animation account provides access to default animations and allows the user to setup a user profile that can be shared with other users having animation accounts. Through an animation account, a user can also share the user's local animations with other users.

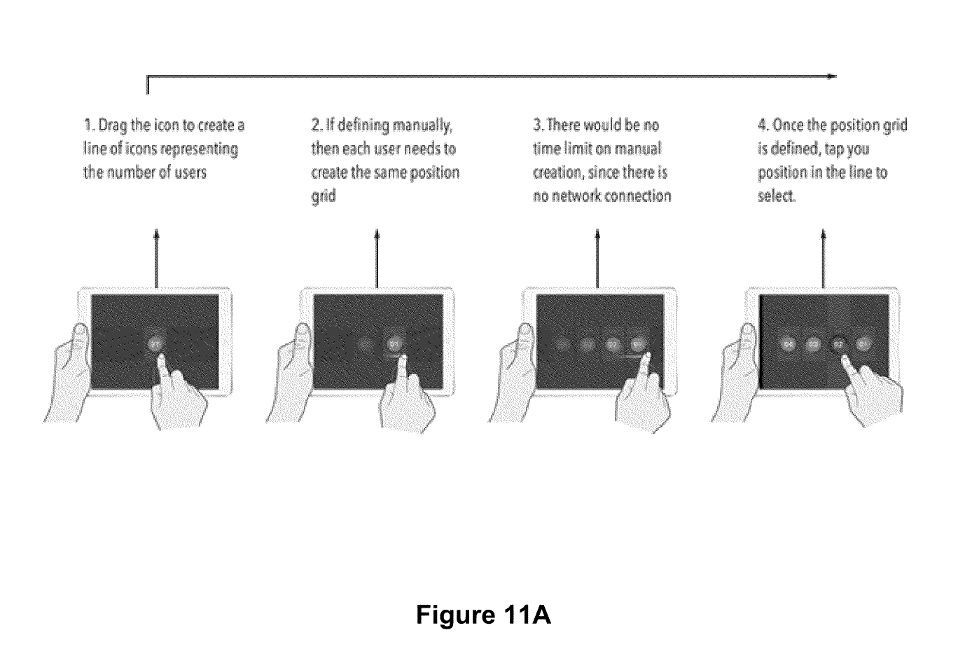

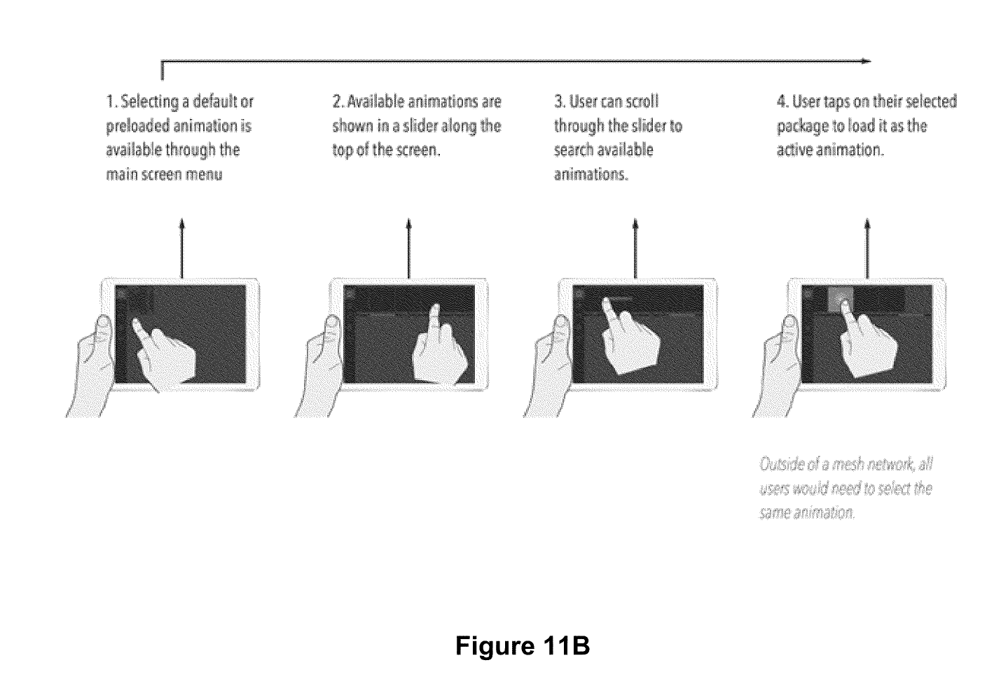

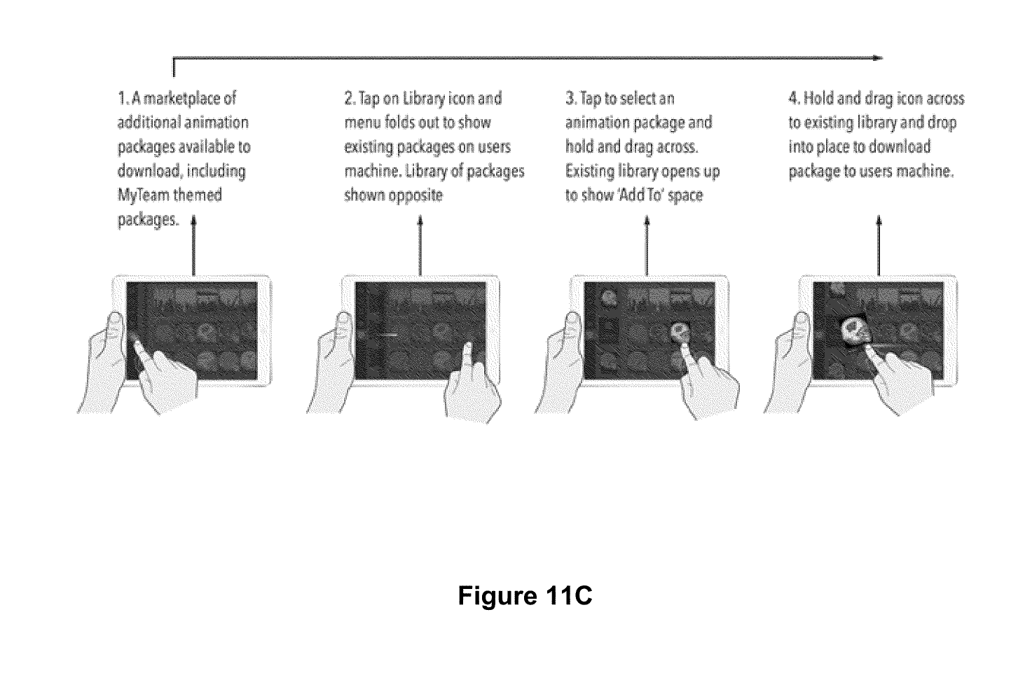

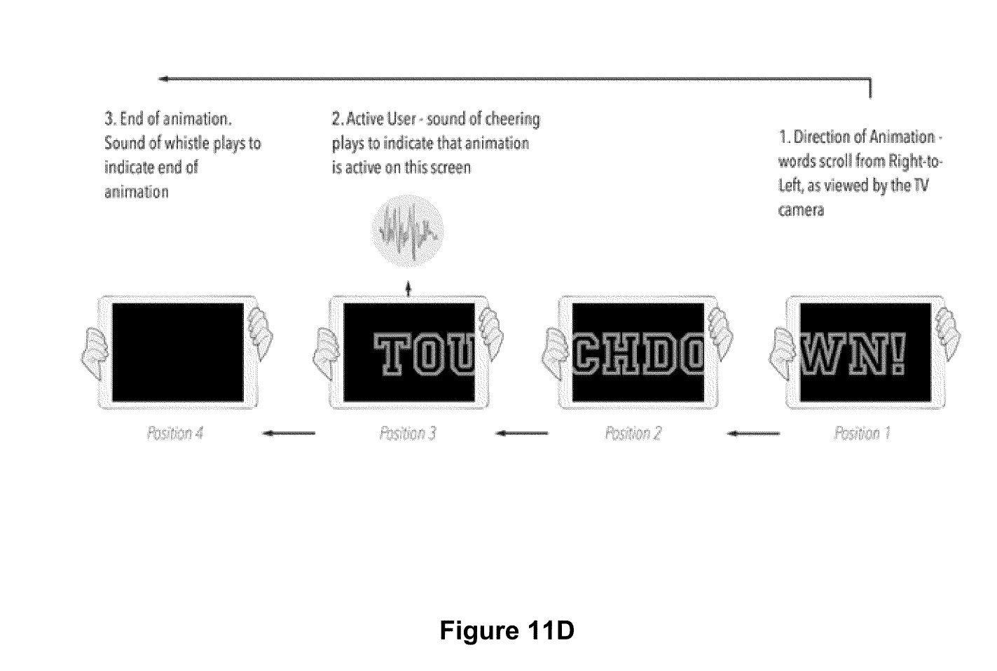

FIGS. 11A-D illustrate workflow examples of applying methods 100 and 1000 through the animation UI, according to some embodiments. FIG. 11A illustrates a workflow embodiment of creating a grid of relative positions and selecting a relative position according to steps 105 and 110. FIG. 11B illustrate a workflow embodiment of selecting an animation for being displayed according to step 115. FIG. 11C illustrates a workflow embodiment of adding an animation to the animation library of the device. In some embodiments, a user selects an animation from the animation library stored on the user's device according to step 115. FIG. 11D illustrates a workflow embodiment of displaying a portion of the selected animation and changing the displayed portion while the animation moves across the devices according to steps 125 and 130.

### Computing Machine Architecture

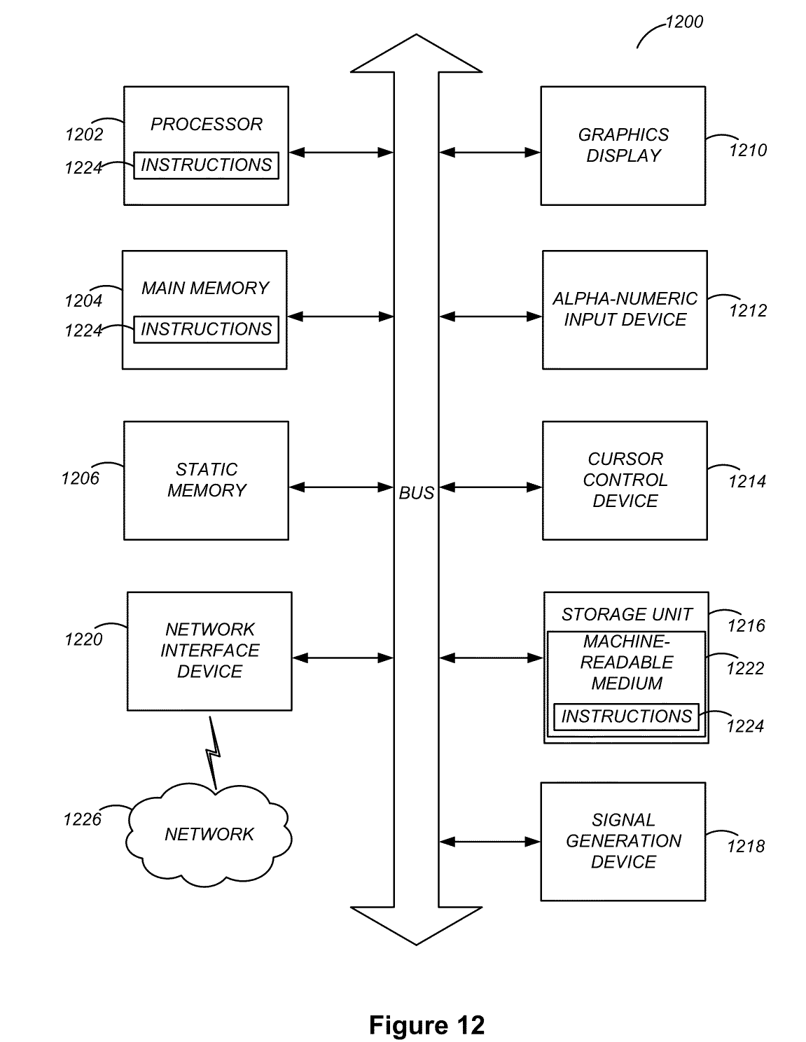

FIG. 12 is a block diagram illustrating components of an example machine able to read instructions from a machine-readable medium and execute them in a processor (or controller). Specifically, FIG. 12 shows a diagrammatic representation of a machine in the example form of a computer system 1200 within which instructions 1224 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet computer, a set-top box (STB), a personal digital assistant (PDA), a cellular telephone, a smartphone, a web appliance, a network router, switch or bridge, or any machine capable of executing instructions 1224 (sequential or otherwise) that specify actions to be taken by that machine. Further, while only a single machine is illustrated, the term “machine” shall also be taken to include any collection of machines that individually or jointly execute instructions 1224 to perform any one or more of the methodologies discussed herein.

The example computer system 1200 includes a processor 1202 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1204, and a static memory 1206, which are configured to communicate with each other via a bus 1208. The computer system 1200 may further include graphics display unit 1220 (e.g., a plasma display panel (PDP), a liquid crystal display (LCD), a projector, or a cathode ray tube (CRT)). The computer system 1200 may also include alphanumeric input device 1212 (e.g., a keyboard), a cursor control device 1214 (e.g., a mouse, a trackball, a joystick, a motion sensor, or other pointing instrument), a storage unit 1216, a signal generation device 1218 (e.g., a speaker), and a network interface device 1220, which also are configured to communicate via the bus 1208.

The storage unit 1216 includes a machine-readable medium 1222 on which is stored instructions 1224 (e.g., software) embodying any one or more of the methodologies or functions described herein. The instructions 1224 (e.g., software) may also reside, completely or at least partially, within the main memory 1204 or within the processor 1202 (e.g., within a processor's cache memory) during execution thereof by the computer system 1200, the main memory 1204 and the processor 1202 also constituting machine-readable media. The instructions 1224 (e.g., software) may be transmitted or received over a network 1226 via the network interface device 1220.

While machine-readable medium 1222 is shown in an example embodiment to be a single medium, the term “machine-readable medium” should be taken to include a single medium or multiple media (e.g., a centralized or distributed database, or associated caches and servers) able to store instructions (e.g., instructions 1224). The term “machine-readable medium” shall also be taken to include any medium that is capable of storing instructions (e.g., instructions 1224) for execution by the machine and that cause the machine to perform any one or more of the methodologies disclosed herein. The term “machine-readable medium” includes, but not be limited to, data repositories in the form of solid-state memories, optical media, and magnetic media.

### Alternative Applications

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Certain embodiments are described herein as including logic or a number of components, modules, or mechanisms, for example, as illustrated in FIGS. 1, 10, and 12. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors, e.g., processor 1202, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A non-transitory computer readable storage medium storing one or more programs for displaying an animation across a plurality of electronic devices having displays, the one or more programs comprising instructions, which when executed by an electronic device, cause the electronic device to:
receive a display number of the plurality of electronic devices;
receive a relative position of the electronic device with respect to the other electronic devices of the plurality of electronic devices;
select an animation for displaying across the plurality of electronic devices;
determine a start time for displaying the animation; and
in response to a timer reaching the start time, display a portion of the selected animation, the displayed portion being based on the display number and on the relative position of the electronic device;
change the displayed portion while the animation moves across the plurality of electronic devices.

2. The non-transitory computer readable storage medium of claim 1, wherein the determining the start time for displaying the animation comprises synchronizing the timer for displaying the animation.

3. The non-transitory computer readable storage medium of claim 2, wherein the synchronizing the timer for displaying the animation comprises:
detecting an orientation change condition of the electronic device, the orientation change condition coinciding with orientation change conditions detected by the other devices of the plurality of electronic devices; and
in response to detecting the orientation change condition, starting the timer for displaying the animation.

4. The non-transitory computer readable storage medium of claim 3, wherein the orientation change condition is triggered by rotating the electronic device.

5. The non-transitory computer readable storage medium of claim 3, wherein the orientation change condition is triggered by changing the display of the electronic device from facing forward to facing backward to back to facing forward.

6. The non-transitory computer readable storage medium of claim 3, wherein the synchronizing the timer for displaying the animation comprises detecting a contact with the display, wherein the display has a touch-sensitive surface.

7. The non-transitory computer readable storage medium of claim 2, wherein the synchronizing the time for displaying the animation comprises detecting an audio signal by the electronic device.

8. The non-transitory computer readable storage medium of claim 2, wherein a time when the timer is synchronized and the determined start time of the animation differ by a specified time threshold.

9. The non-transitory computer readable storage medium of claim 1, wherein the instructions when executed by the electronic device further cause the electronic device to:
arrange the plurality of electronic devices in a row adjacent to one another, the relative position of the electronic device being a position in the row of arranged electronic devices; and
display different portions of the animation across the row of arranged electronic devices so that the animations moves from left side of the row to right side of the row and looping back to the left side.

10. The non-transitory computer readable storage medium of claim 1, wherein the instructions when executed by the electronic device further cause the electronic device to:
arrange the plurality of electronic devices in a two-dimensional grid;
wherein the relative position of the electronic device is a position in the two-dimensional grid of the plurality of electronic devices.

11. The non-transitory computer readable storage medium of claim 9, wherein the instructions when executed by the electronic device further cause the electronic device to:
display different portions of the animation across the two-dimensional grid of arranged electronic devices so that the animation moves from left side of the grid to right side of the grid starting from bottom of the grid to top of the grid and looping back to the left side at the bottom of the grid.

12. The non-transitory computer readable storage medium of claim 9, wherein the instructions when executed by the electronic device further cause the electronic device to:
display different portions of the animation across the two-dimensional grid of arranged electronic devices so that the animation moves from left side of the grid to right side of the grid starting from top of the grid to bottom of the grid and looping back to the left side at the top of the grid.

13. The non-transitory computer readable storage medium of claim 1, wherein the instructions when executed by the electronic device further cause the electronic device to:
prior to selecting the animation for displaying across the plurality of electronic devices, download a plurality of predefined animations to each electronic device; and
display the downloaded plurality of predefined animations to select the animation for displaying across the electronic devices.

14. The non-transitory computer readable storage medium of claim 13, wherein displaying the downloaded plurality of predefined animations to select the animation comprises grouping the displayed animations according to animation categories.

15. The non-transitory computer readable storage medium of claim 1, wherein the selecting the animation for displaying across the plurality of electronic devices comprises entering text that is displayed as part of the animation, selecting objects that are included as part of the animation, and defining an arrangement of the entered text and the selected objects during the animation, wherein the arrangement comprises a rate and a direction of movement of the text and the objects.

16. The non-transitory computer readable storage medium of claim 1, wherein the electronic devices are not required to communicate with each other while receiving the display number and relative position, while selecting the animation, while determining the start time, and while displaying portions of the animation.

17. The non-transitory computer readable storage medium of claim 16, wherein the electronic devices determine the start time through a trigger event communicated to each electronic device over a network that connects the electronic devices with the other devices of the plurality of electronic devices.

18. The non-transitory computer readable storage medium of claim 1, wherein the displayed portion is further based on a length of the animation and on a time that elapses while the animation moves across all electronic devices.

19. A computer-implemented method for displaying an animation across a plurality of electronic devices having displays, the method comprising:
at an electronic device with a display:
receiving a display number of the plurality of electronic devices;
receiving a relative position of the electronic device with respect to other electronic devices of the plurality of electronic devices;
selecting an animation for displaying across the plurality of electronic devices;
determining a start time for displaying the animation; and
displaying, in response to a timer reaching the start time, a portion of the selected animation, the displayed portion being based on the display number and on the relative position of the electronic device;
changing the displayed portion while the animation moves across the plurality of electronic devices.

20. An electronic device for displaying an animation across a plurality of electronic devices, comprising:
a display;
one or more processors;
memory; and
one or more programs, wherein the one or more programs are stored in the memory and configured to be executed by the one or more processors, the one or more programs including instructions when executed by the electronic device cause the electronic device to:
receive a display number of the plurality of electronic devices;
receive a relative position of the electronic device with respect to the other electronic devices of the plurality of electronic devices;
select an animation for displaying across the plurality of electronic devices;
determine a start time for displaying the animation; and
in response to a timer reaching the start time, display a portion of the selected animation, the displayed portion being based on the display number and on the relative position of the electronic device;
change the displayed portion while the animation moves across the plurality of electronic devices.
